(19) United States
(12) Patent Application Publication
(10) Pub. No.: US 2005/0021957 A1
(43) Pub. Date: Jan. 27, 2005

(54) Authentication method in wire/wireless communication system using markup language

(75) Inventor: Se-Wan Gu, Seoul (KR)

Correspondence Address: FLESHNER & KIM, LLP, P.O. BOX 221200, CHANTILLY, VA, 20153, US

(73) Assignee: LG Electronics Inc.

(21) Appl. No.: 10/865,765

(22) Filed: Jun. 14, 2004

(30) Foreign Application Priority Data
Jun. 14, 2003 (KR) 38545/2003

(51) Int. Cl. H04L 9/00

(52) U.S. Cl. 713/170

(57) ABSTRACT

An authentication method is provided between a client and a server in a wire/wireless communication system using a markup language. A variety of authentication methods are defined in an extensible markup language document type definition (XML DTD) by using an extensible authentication protocol (EAP). An authentication process is performed between the client and the server by using one authentication method randomly selected from the authentication methods.

The present application claims priority from Korean Patent Application No. 38545/2003, filed Jun. 14, 2003, the subject matter of which is incorporated herein by reference.

### BACKGROUND OF THE INVENTION

1. Field of the Invention

Embodiments of the present invention may relate to authentication in a wire/wireless communication system using a markup language. More particularly, embodiments of the present invention may relate to an authentication method between a client and a server in a wire/wireless communication system using a synchronization markup language (SyncML).

2. Background of Related Art

When requesting access authentication between a client and a server in a wire/wireless communication system using a markup language, if the authentication is successfully performed, then access can be maintained and operations may proceed. For example, when data synchronization is necessary due to dispersion of the same data in the wire/wireless network and corresponding terminals, an authentication process may be required between a client and a server to maintain data synchronization.

SyncML is a standard protocol for data synchronization that may be used for synchronization of personal information on a web portal, cellular phone, or PC, for example. In addition, SyncML can support a data synchronization function for various application services such as an E-mail, a text memo as well as management functions for personal information.

FIG. 1 illustrates an authentication method between a client and a server in data synchronization of a communication system using SyncML according to an example arrangement. Other arrangements are also possible. As shown, when data synchronization is performed between a client and a server using SyncML, the client requests data synchronization to the server in operation S10. The server requests an identity and a password from the client in operation S12. The client may encode its identity and password, or compress its identity and password by a predetermined algorithm such as MD5, for example. The client may further encode the compressed identity and password and transmit the encoded identity and password to the server in operation S14. The server may confirm the identity and password and notify authentication results in operation S16.

When authentication for the client has been successfully performed, the server may transmit its identity and password to the client to be authenticated by the client. The client may confirm the identity and password and notify the server of the authentication result. When bi-directional authentication has been successfully completed, a bi-directional or one-way data synchronization procedure may be performed between the client and the server.

An authentication method in the communication system using the markup language may perform authentication merely by using identities and passwords. However, security information may be leaked to a third party. A special authentication server to compensate for weak security of the authentication protocol can also be used. However, this type of authentication server may be difficult and costly to additionally install.

### SUMMARY OF THE INVENTION

Embodiments of the present invention may provide an authentication method in a wire/wireless communication system using a markup language that can select among various authentication methods between a client and a server. A structured protocol may be used for a message in the markup language to have various authentication methods.

Embodiments of the present invention may provide an authentication method using a markup language that can perform strong bi-directional authentication by dynamically selecting authentication methods between a client and a server in a wire/wireless communication system.

An authentication method may be provided that declares various authentication methods in a document type definition (DTD) for declaring a markup language structure. The method may further dynamically select the authentication between a client and a server from the declared authentication methods.

When the client transmits an access request, the server may randomly select one of the authentication methods, and request security information from the client based on the randomly-selected authentication method.

An authentication method may be provided between a client and a server in a wire/wireless communication system using a markup language. This may include recognizing identical authentication methods between the client and the server, and authenticating the client (at the server) by using one random authentication method of the identical authentication methods. The method may also include authenticating the server (at the client) by using another random authentication method of the identical authentication methods. The one random authentication method and the another random authentication method may be the same or different from one another.

An authentication protocol may be provided that includes an extensible markup language document type definition (XML DTD) for declaring various authentication methods by using an extensible authentication protocol (EAP) element. The authentication protocol may also use an authentication message that includes an EAP element having information of the one random authentication method of the declared authentication methods.

The EAP element may include a <Code> element for indicating a type of the authentication message and an <Identifier> element for identifying the authentication message, and also include an <EAPData> element for containing actual data of the authentication message.

The <EAPData> element may include a <DataKind> element for indicating a type of the data, and an information element having information of the random authentication method.

Other objects, features, aspects, advantages and embodiments of the present invention may become more apparent from the following detailed description when taken in conjunction with the accompanying drawings.

### BRIEF DESCRIPTION OF THE DRAWINGS

The accompanying drawings are included to provide a further understanding of the invention and are incorporated in and constitute a part of this specification. The drawings illustrate embodiments of the invention and together with the description serve to explain the principles of the invention.

The following represents brief descriptions of the drawings in which like reference numerals represent like elements and wherein:

FIG. 1 illustrates a authentication method between a client and a server of a communication system using a markup language according to an example arrangement;

FIG. 2 illustrates an XML DTD in accordance with an example embodiment of the present invention;

FIG. 3 illustrates a confirmation method for available authentication methods between a client and a server in accordance with an example embodiment of the present invention;

FIG. 4 illustrates an authentication method for data synchronization between the client and the server in accordance with an example embodiment of the present invention;

FIG. 5 illustrates an authentication message (e.g., EAP-Request/Identity message) for requesting an identity using an EAP in accordance with an example embodiment of the present invention;

FIG. 6 illustrates an authentication message (e.g., EAP-Response/Identity message) for responding to an actual value of the identity by using the EAP in accordance with an example embodiment of the present invention;

FIG. 7 illustrates an authentication message (e.g., EAP-Request/Challenge message) for requesting security information according to a random authentication method using the EAP in accordance with an example embodiment of the present invention;

FIG. 8 illustrates an authentication message (e.g., EAP-Response/Credentials message) for responding to the security information according to the random authentication method using the EAP in accordance with an example embodiment of the present invention; and

FIG. 9 illustrates an authentication message for transmitting an authentication result using the EAP in accordance with an example embodiment of the present invention.

### DETAILED DESCRIPTION OF PREFERRED EMBODIMENTS

Data synchronization may be performed by transmitting/receiving a message based on an extensible markup language (XML) between a client and a server. Protocol for data synchronization may include a representation protocol, a synchronization protocol and a transport protocol.

The synchronization protocol may define a method and procedure for exchanging a SyncML message between the client and the server, a method for performing synchronization, and a synchronization type. The transport protocol may define binding rules for using transport protocols such as a hyper text transport protocol (HTTP) and a wireless session protocol (WSP) for message transport.

The representation protocol is a structure protocol for the SyncML message that defines an extensible markup language document type definition (XML DTD) for synchronization. The XML DTD that declares a markup language used in the XML document may define logical and physical structures for the document.

Language rules used to make up a document may be exactly transmitted to all the users so that the users can recognize the contents of the document. XML clarifies the language rules using the DTD. That is, the DTD describes elements used in the XML document, attributes of the elements, relations between the elements an d entities.

In accordance with example embodiments of the present invention, a plurality of authentication methods may be defined in the XML DTD in advance. The client and the server may randomly select a few authentication methods from the defined authentication methods. The client and the server may compare their authentication methods, and recognize identical authentication methods. In bi-directional authentication for data synchronization, the client and the server may dynamically suggest their authentication methods to each other from among the identical authentication methods. This may allow a safe authentication procedure.

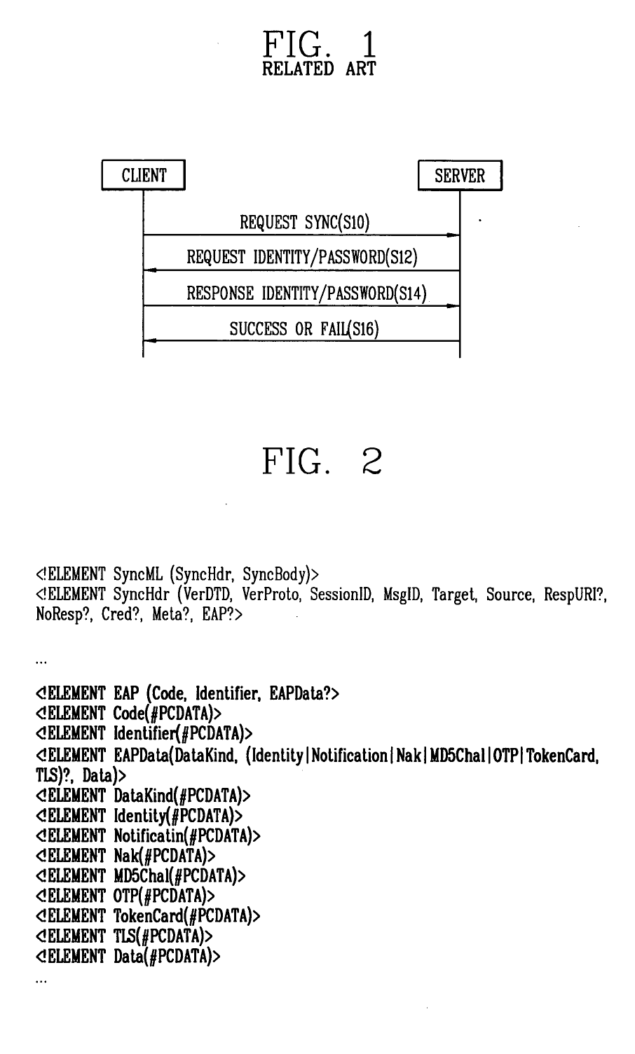

In accordance with an example embodiment of the present invention, a SyncML schema for an extensible authentication method may be defined for randomly selecting and deciding the authentication method between the client and the server and to design an XML DTD such as shown in FIG. 2.

FIG. 2 illustrates an XML DTD in accordance with an example embodiment of the present invention. Other embodiments are also within the scope of the present invention. The XML DTD may include a schema by an extensible authentication protocol (EAP) defined in IETF RFC 2284 in order to obtain various authentication methods.

The XML DTD may explain a structure of the SyncML message. According to the XML DTD, the SyncML message may include a header element <SyncHdr> and a body element <SyncBody>. The header element <SyncHdr> may include DTD version <VerDTD>, protocol version <VerProto>, message ID <MsgID>, <Target>, <Source>, <RespURI>, <NoResp>, <Cred>, <Meta> and <EAP> elements. The <Target>, <Source>, <RespURI>, <NoResp>, <Cred> and <Meta> elements may not relate to the EAP, and therefore explanations thereof are omitted. The body element may include a plurality of commands for performing a data synchronization procedure, but explanations may also be omitted.

The <EAP> element may include a <Code> element, an <Identifier> element and a <EAPData> element. The <Code> element may indicate a kind of the EAP message that includes Request, Response, Success and Fail information. The <Identifier> element may be an identifier for identifying the EAP message. The <EAPData> element that contains actual data of the EAP message may include information of authentication. The <EAPData> element may include one of <Identity>, <Notification>, <Nak>, <MD5Chal>, <OTP>, <TokenCard> and <TLS> elements as well as <DataKind> element.

The <Identity> element may indicate an authentication method using an identity of the client or server. The <Notification> element may indicate notices that must be notified to the other party. The <Nak> element may imply ‘authentication is not necessary, do not respond’, and the <MD5Chal> element may be used to request or respond to a challenge using an MD5 compression algorithm. The <OTP> element may indicate an authentication method using a one time password (OTP) algorithm. The <TokenCard> element may indicate an authentication method using information (token) by a physical input, such as a smart card input, a pupil input and/or a fingerprint input. The <TLS> element is a standard suggested by the IETF that indicates an authentication method for providing encoding and certification by a transport layer (e.g. transmission control protocol (TCP)) so that data can be transmitted through a secure channel without modifying application programs of the client and the server. That is, the <TLS> element may indicate an authentication method using a certificate, for example.

In accordance with an example embodiment of the present invention, the XML DTD may declare a plurality of authentication method, such as the Identity/Password-based authentication method, the MD5-based authentication method, the OTP-based authentication method, the TokenCard-based authentication method and the certificate-based authentication method using TLS (transport layer security). Other authentication methods are also within the scope of the present invention.

Because the XML DTD may declare the plurality of authentication methods, the client and the server using SyncML can selectively include a predetermined number of authentication methods from among declared authentication methods.

The client and the server may include an authentication agent to perform a SyncML-based EAP procedure by the schema suggested to declare the plurality of authentication methods.

Each of the clients and each of the servers may have different authentication methods. Therefore, before starting the authentication procedure for data synchronization, the client and server may notify each other of their authentication methods and then recognize identical available authentication methods.

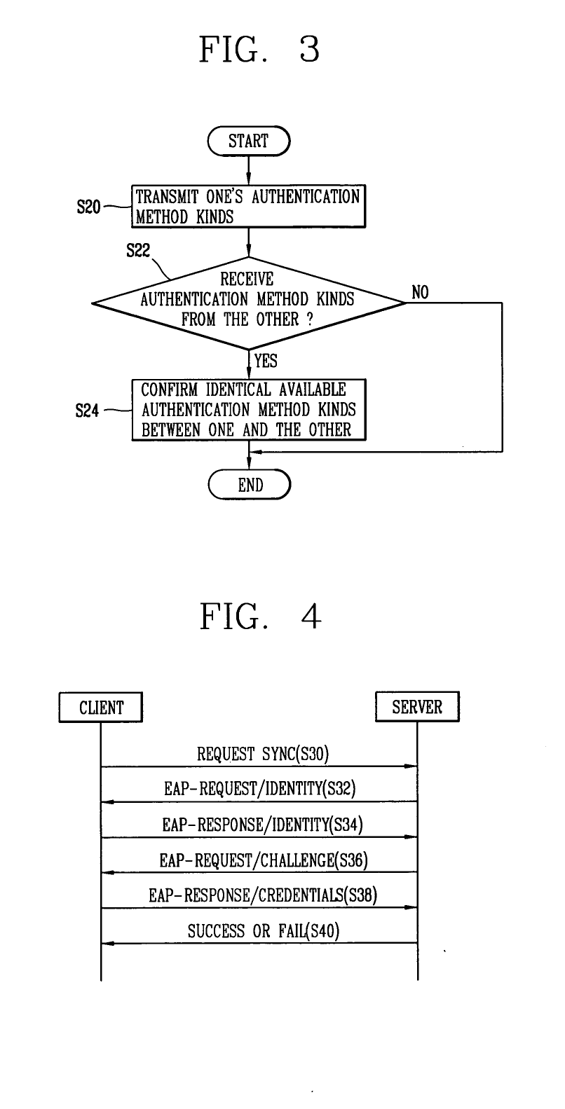

FIG. 3 illustrates a confirmation method for available authentication methods between a client and a server in accordance with an example embodiment of the present invention. Other embodiments are also within the scope of the present invention.

When the client and the server may require data synchronization, the client may transmit its authentication methods to the server in operation S20. The client may receive the authentication methods of the server from the server in operation S22.

The client may compare its authentication methods with the server's authentication methods, and recognize identical available authentication methods in operation S24. In addition, the server may recognize the identical available authentication methods between its authentication method and the authentication method of the client. For example, when the client's authentication methods are Identity, MD5Chal, OTP and TLS and the server's authentication methods are Identity, MD5Chal, OTP, TokenCard and TLS, then the client and the server may confirm the identical Identity, MD5Chal, OTP and TLS authentication methods. After confirming the identical available authentication methods, the client and the server may perform the authentication procedure for data synchronization.

FIG. 4 illustrates an authentication method for data synchronization between the client and the server in a communication system using SyncML in accordance with an example embodiment of the present invention. Other embodiments are also within the scope of the present invention.

As shown in FIG. 4, the client may request data synchronization to the server in operation S30. The server may request an identity of the client in operation S32. The client may transmit its identity to the server upon receiving the request in operation S34. In order to confirm that the client actually owns the identity, the server may randomly select one of the identical available authentication methods between the server and the client, and request security information of the client's identity based on the selected authentication method in operation S36. The client may transmit its security information to the server based on the selected authentication method in operation S38. When the client's security information is normal security information, the server may decide that the authentication has been successfully performed based on the randomly-selected authentication method, and may transmit success information to the client in operation S40. The server may also request authentication to the client in a similar manner and therefore this methodology may not be explained in any further detail.

The authentication method of the client by the server will now be further described. The client may attempt to access the server to request data synchronization. That is, the client may generate a data synchronization request message Request Sync, and transmit the generated message Request Sync to the server through a TCP/IP in operation S30.

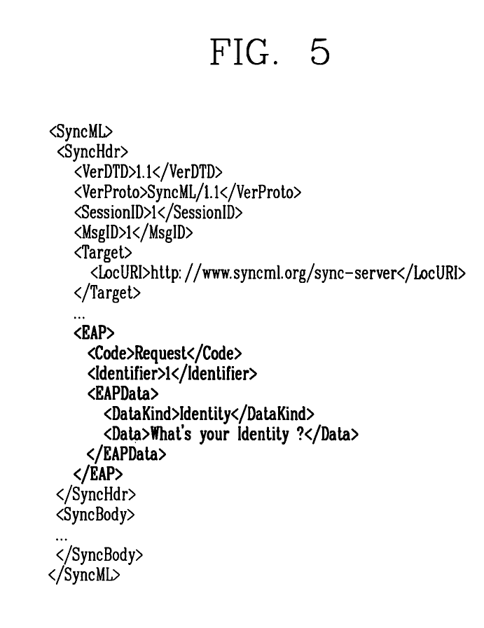

FIG. 5 illustrates an authentication message (e.g., EAP-Request/Identity message) for requesting an identity using an EAP in accordance with an example embodiment of the present invention. Other embodiments are also within the scope of the present invention. In order to use the EAP, the server generates a first EAP request message EAP-Request/Identity for requesting an identity by using the <EAP> element and sub-elements thereof The first EAP request message EAP-Request/Identity includes a <Code> element for indicating a request, an <Identifier> element for indicating ‘1’, and a <EAPData> element as sub-elements of the <EAP> element. The <EAPData> element includes a <DataKind> element for indicating an identity according to the selected authentication method and a <Data> element for indicating data that the client will display to the user. The server transmits the first EAP request message EAP-Request/Identity to the client in operation S32.

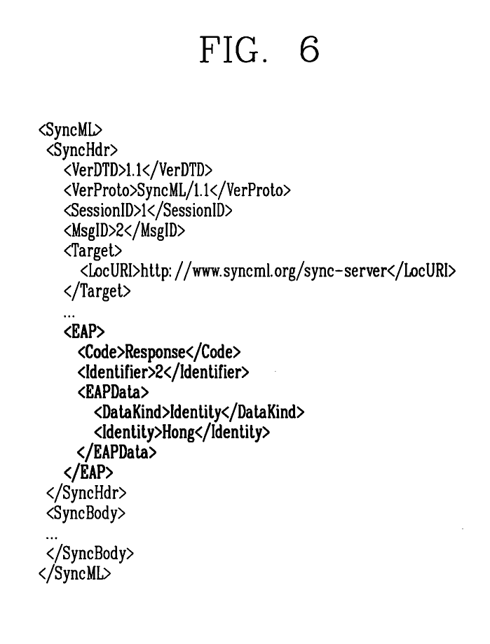

The client analyzes the first EAP request message EAP-Request/Identity. When the client detects the <EAP> element, the client recognizes that the authentication process is to be performed using the EAP and also recognizes that the first EAP request message EAP-Request/Identity is an authentication message for requesting an identity on the basis of the <Code> element and the <DataKind> element of the <EAP> element. The client then generates a first EAP response message EAP-Response/Identity, such as shown in FIG. 6. More specifically, FIG. 6 shows an EAP-Response/Identity message for responding an actual identity. That is, the client records ‘Response’ as the <Code> element of the <EAP> element of the first EAP response message EAP-Response/Identity, and records ‘Identity’ as the <DataKind> element of the <EAPData> element. When the identity of the client is ‘Hong’, the client also records ‘Hong’ as the <Identity> element. The client transmits the first EAP response message EAP-Response/Identity to the server in operation S34.

The server analyzes the first EAP response message EAP-Response/Identity. The server recognizes that the client having the identity of ‘Hong’ is waiting for authentication based on <Code>Response</Code>, <DataKind>Identity</DataKind> and <Identity>Hong</Identity> of the <EAP> element of the first EAP response message EAP-Response/Identity. Accordingly, the server randomly selects one of the available authentication methods, and requests security information of the client's identity according to the selected authentication method in order to confirm that the client actually owns the identity of ‘Hong’. Stated differently, the server attempts to perform the actual authentication process.

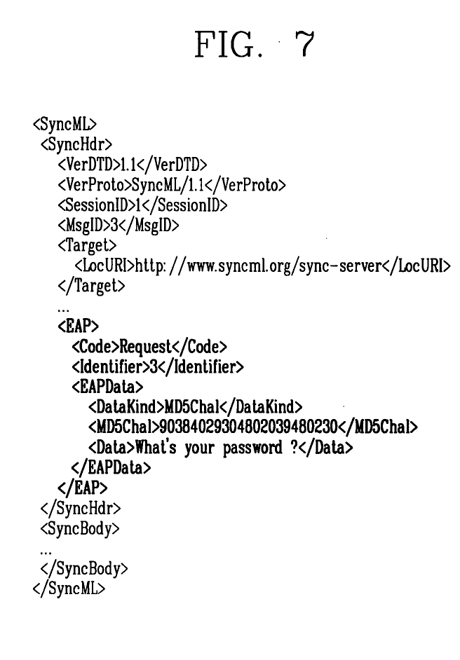

When the authentication method randomly selected from the available authentication methods by the server is ‘MD5Chal’, as shown in FIG. 7, the server records ‘Request’ as the <Code> element of the <EAP> element, ‘MD5Chal’ as the <DataKind> element of the <EAPData> element, a random value (e.g., ‘90384029304802039480230’) as the <MD5Chal> element, and ‘What's your password?’ as the <Data> element, so as to generate a second EAP request message EAP-Request/challenge. In other words, FIG. 7 shows an EAP-Request/Challenge message for requesting security information. In the situation that the authentication method randomly selected from the available authentication methods is ‘OTP’, the server includes <DataKind>OTP<DataKind> and <OTP>x<OTP>, thereby generating the second EAP request message EAP-Request/challenge. The server transmits the second EAP request message EAP-Request/challenge to the client in operation S36.

The client receiving the second EAP request message EAP-Request/challenge then recognizes that the client must respond with the password (security information) of its identity to the server with the random value recorded on the <MD5Chal> element by using an MD5 compression algorithm based on <DataKind>MD5Chal<DataKind> and <MD5Chal>90384029304802039480230</MD5Chal> of the <EAP> element.

The client calculates a response value by using the password (security information) of its identity and the random value recorded on the <MD5Chal> element through the MD5 compression algorithm, as shown by the following Formula 1:
MD5(Random value+Password+α) Formula 1

In this formula, α denotes a preset value for identifying an identity, such as a resident registration number. For example, the client compresses the random value, its password and α through the MD5 compression algorithm. The compression result value (i.e., the response value) has a predetermined number of bits (for example, 128 bits), and an input value is not obtained from the result value. MD5 is an irreversible function and therefore if the compression result value (response value) is determined by a third party, the password cannot be inferred.

In the situation that <DataKind>OTP<DataKind> and <OTP>x<OTP> are recorded on the <EAP> element of the second EAP request message EAP-Request/challenge, the client prepares a response value by using the received ‘x’ and its password.

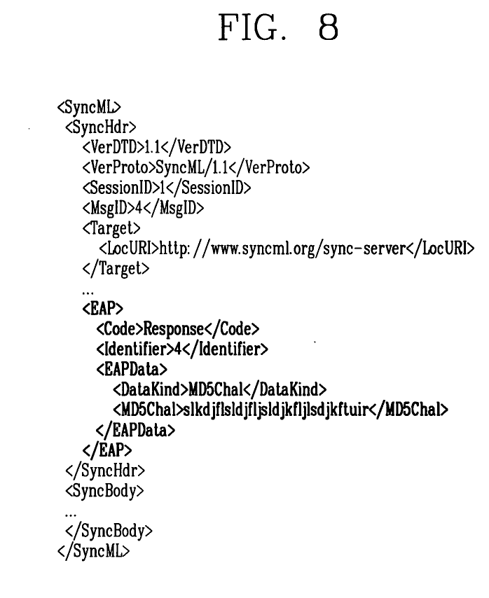

The client generates a second EAP response message EAP-Response/Credentials to have the response value as shown in FIG. 8, and transmits the second EAP response message EAP-Response/Credentials to the server (S38). More specifically, FIG. 8 shows an EAP-Response/Credentials message for responding with the security information. In the second EAP response message EAP-Response/Credentials of FIG. 8, ‘slkdjflsldjfljsldjkfljlsdjkftuir’ recorded as a value of the <MD5Chal> element denotes the response value.

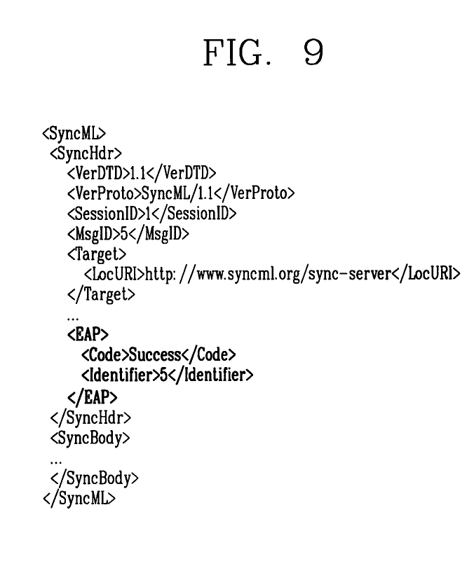

The server receiving the second EAP response message EAP-Response/Credentials searches a password of the corresponding identity from a user registration database. The server compresses the searched password and the random value transmitted from the server to the client as a challenge in the same manner as Formula 1. The server compares the value calculated by the compression with the response value from the client. When the calculated value is identical to the response value, the server decides that the authentication has been successfully performed according to the randomly-selected authentication method. On the other hand, when the calculated value is different from the response value, the server decides that the authentication has failed. FIG. 9 illustrates an authentication message for transmitting an authentication result. As shown in FIG. 9, the server generates an authentication result message by recording an authentication result as the <Code> element of the <EAP> element, and transmits the authentication result message to the client in operation S40.

The client receiving the authentication result message (of FIG. 9) recognizes that the authentication has been successfully performed on the basis of <Code>Success</Code>. The authentication result message does not need the <EAPData> element.

Accordingly, a variety of authentication methods may be defined in the XML DTD so that the authentication methods can be freely selected between the client and the server using the markup language. Furthermore, the authentication methods can be dynamically selected between the client and the server. This may result in strong bi-directional authentication.

Embodiments of the present invention may be embodied in several forms without departing from the spirit or essential characteristics thereof. It should also be understood that the above-described embodiments are not limited by any of the details of the foregoing description but rather should be construed broadly within its spirit and scope as defined in the appended claims. Therefore all changes and modifications that fall within the metes and bounds of the claims, or equivalence of such metes and bounds are therefore intended to be embraced by the appended claims.

1. An authentication method comprising:
declaring authentication methods in a document type definition (DTD) for declaring a markup language structure; and
selecting one of the declared authentication methods.

2. The method of claim 1, wherein the authentication methods comprise at least one member of a group of an Identity/Password-based authentication method, an MD5-based authentication method, a one time password (OTP)-based authentication method, a TokenCard-based authentication method and a certificate-based authentication method using transport layer security (TLS).

3. The method of claim 1, wherein declaring the authentication methods comprises using an extensible authentication protocol (EAP).

4. The method of claim 1, further comprising recognizing similar available authentication methods.

5. The method of claim 1, wherein selecting one of the authentication methods comprises when the client transmits an access request, the server selecting one of the authentication methods, and requesting security information from the client according to the selected authentication method.

6. The method of claim 5, wherein the server further transmits to the client a request message including the selected authentication method and a request for security information according to the authentication method.

7. The method of claim 6, wherein when the client receives the request message, the client detects the authentication method and the request for the security information from the request message, and transmits the security information to the server as a response according to the authentication method.

8. The method of claim 7, wherein the authentication method is detected based on information of a <DataKind> element of an <EAPData> element of the <EAP> element.

9. The method of claim 7, wherein the request message comprises a random value.

10. The method of claim 9, wherein a response by the authentication method comprises a value obtained by processing the random value, the security information and a set value according to the detected authentication method, and wherein the random value is detected from the request message.

11. The method of claim 10, wherein the set value comprises another value to identify the client.

12. The method of claim 7, wherein the server searches security information that the server has requested to the client from a database, processes the searched security information according to the selected authentication method, and compares the processed value with the response from the client to determine authentication success/failure.

13. The method of claim 1, wherein the selected authentication method comprises a randomly selected authentication method.

14. An authentication method comprising:
recognizing identical authentication methods;
authenticating, at a server, a client by using one random authentication method of the identical authentication methods; and
authenticating, at the client, the server by using another random authentication method of the identical authentication methods.

15. The method of claim 14, further comprising defining the authentication method in a document type definition (DTD) for declaring a markup language structure by using an extensible authentication protocol (EAP).

16. The method of claim 14, wherein the authentication methods comprise at least one member of a group of an Identity/Password-based authentication method, an MD5-based authentication method, a one time password (OTP)-based authentication method, a TokenCard-based authentication method, and a certificate-based authentication method using transport layer security (TLS).

17. The method of claim 14, wherein the one random authentication method is different from the another random authentication method.

18. The method of claim 14, wherein the one random authentication method is similar to the another random authentication method.

19. An authentication protocol comprising:
an extensible markup language document type definition (XML DTD) for declaring a plurality of authentication methods by using an extensible authentication protocol (EAP) element; and
an authentication message including an EAP element having information of one random authentication method of the declared authentication methods.

20. The authentication protocol of claim 19, wherein the EAP element comprises a <Code> element for indicating a kind of the authentication message and an <Identifier> element for identifying the authentication message.

21. The authentication protocol of claim 20, wherein the EAP element further comprises an <EAPData> element for containing actual data of the authentication message.

22. The authentication protocol of claim 20, wherein the <EAPData> element comprises a <DataKind> element for indicating a kind of the data, and an information element having information of the random authentication method.

23. An authenticating method comprising:
determining a plurality of authentication methods between a client and a server;
authenticating the client based on one of the authenticating methods; and
authenticating the server based on one of the authenticating methods.

24. The method of claim 23, wherein determining the plurality of authentication methods comprises recognizing identical authentication methods.

25. The method of claim 23, further comprising defining the authentication method in a document type definition (DTD) for declaring a markup language structure by using an extensible authentication protocol (EAP).

26. The method of claim 23, wherein the authentication methods comprise at least one member of a group of an Identity/Password-based authentication method, an MD5-based authentication method, a one time password (OTP)-based authentication method, a TokenCard-based authentication method, and a certificate-based authentication method using transport layer security (TLS).

27. The method of claim 23, wherein the client is authenticated using an authentication method different than an authentication method of the server.

28. The method of claim 23, wherein the client is authenticated using an authentication method similar to an authentication method of the server.
